(19) United States
(12) Patent Application Publication
(10) Pub. No.: US 2017/0116888 A1
(43) Pub. Date: Apr. 27, 2017

(54) Body Tissue Model Including A Simulated Pathology

(71) Applicant: SurgiReal Products, Inc., Fort Collins, CO (US)

(72) Inventor: Fausto Bellezzo, Saint Paul, MN (US)

(73) Assignee: SurgiReal Products, Inc., Fort Collins, CO (US)

(21) Appl. No.: 15/299,693

(22) Filed: Oct. 21, 2016

Related U.S. Application Data
(60) Provisional application No. 62/245,394, filed on Oct. 23, 2015.

(51) Int. Cl. G09B 23/34; G09B 23/30

(52) U.S. Cl. CPC G09B 23/34; G09B 23/30

(57) ABSTRACT

Disclosed herein are embodiments of a body tissue model including a simulated pathology, and methods of making and using such a body tissue model including a simulated pathology, whereby the body tissue model includes simulated body tissue which defines a closed cavity having a closed cavity interior space; and a flowable simulated pathological fluid disposed within the closed cavity interior space; wherein the flowable simulated pathological fluid provides at least a portion of the simulated pathology.

This U.S. Non-Provisional Patent Application claims the benefit of U.S. Provisional Patent Application No. 62/245,394, filed Oct. 23, 2015, hereby incorporated by reference herein.

### SUMMARY OF THE INVENTION

A broad object of a particular embodiment of the invention can be to provide a body tissue model including a simulated pathology, and methods of making and using such a body tissue model including a simulated pathology, whereby the body tissue model includes simulated body tissue which defines a closed cavity having a closed cavity interior space; and a flowable simulated pathological fluid disposed within the closed cavity interior space; wherein the flowable simulated pathological fluid provides at least a portion of the simulated pathology.

Another broad object of a particular embodiment of the invention can be to provide a body tissue model including a simulated pathology, wherein the flowable simulated pathological fluid simulates an abscess.

Another broad object of a particular embodiment of the invention can be to provide a body tissue model including a simulated pathology, wherein the flowable simulated pathological fluid is encapsulated within a rupturable capsule to provide encapsulated flowable simulated pathological fluid; and wherein the encapsulated flowable simulated pathological fluid provides the simulated pathology.

Another broad object of a particular embodiment of the invention can be to provide a body tissue model including a simulated pathology, wherein the encapsulated flowable simulated pathological fluid simulates a cyst.

Naturally, further objects of the invention are disclosed throughout other areas of the specification, drawings, and claims.

### II. A BRIEF DESCRIPTION OF THE DRAWINGS

FIG. 1A is an illustration of a method of using a particular embodiment of the body tissue model including a simulated pathology for incising, which may be useful for honing incision skills.

FIG. 1B is an illustration of a method of using a particular embodiment of the body tissue model including a simulated pathology for excising, which may be useful for honing excision skills.

FIG. 1C is an illustration of a method of using a particular embodiment of the body tissue model including a simulated pathology for draining, which may be useful for honing drainage skills.

FIG. 2A is a perspective view of a particular embodiment of the body tissue model including a simulated pathology, whereby the body tissue model includes a first layer.

FIG. 2B is a perspective view of a particular embodiment of the body tissue model including a simulated pathology, whereby the body tissue model include first, second, third, fourth, and fifth layers.

FIG. 3 is a front view of a particular embodiment of the body tissue model including a simulated pathology, whereby the body tissue model include first, second, third, fourth, and fifth layers.

FIG. 4 is a rear view of a particular embodiment of the body tissue model including a simulated pathology, whereby the body tissue model include first, second, third, fourth, and fifth layers.

FIG. 5 is a first side view of a particular embodiment of the body tissue model including a simulated pathology, whereby the body tissue model include first, second, third, fourth, and fifth layers.

FIG. 6 is a second side view of a particular embodiment of the body tissue model including a simulated pathology, whereby the body tissue model include first, second, third, fourth, and fifth layers.

FIG. 7 is a top plan view of a particular embodiment of the body tissue model including a simulated pathology, whereby the body tissue model include first, second, third, fourth, and fifth layers.

FIG. 8 is a bottom plan view of a particular embodiment of the body tissue model including a simulated pathology, whereby the body tissue model include first, second, third, fourth, and fifth layers.

FIG. 9 is a cross-sectional view 9-9 of the particular embodiment of the body tissue model shown in FIG. 7, including the simulated pathologies.

FIG. 10 is a cross-sectional view 10-10 of the particular embodiment of the body tissue model shown in FIG. 7, showing the closed cavity and the closed cavity interior space void of the simulated pathology.

FIG. 11A is a view of a particular embodiment of an encapsulated flowable simulated pathological fluid of the body tissue model.

FIG. 11B is a cross-sectional view of the particular embodiment of the encapsulated flowable simulated pathological fluid shown in FIG. 11A.

FIG. 12 is a perspective view of a particular embodiment of a mold which may be useful for making the body tissue model.

FIG. 13A is an illustration of a method of using a particular embodiment of the mold shown in FIG. 12 to make the body tissue model, whereby a flowable first layer first amount is being deposited into a mold interior space.

FIG. 13B is an illustration of a method of using a particular embodiment of the mold shown in FIG. 12 to make the body tissue model, whereby the mold can be positioned in angled relation relative to the substantially horizontal position shown in FIG. 13A so that excess flowable first layer first amount does not accumulate on a mold interior lower surface, and particularly, in a recess.

FIG. 13C is an illustration of a method of using a particular embodiment of the mold shown in FIG. 12 to make the body tissue model, whereby simulated pathologies are deposited in the recesses within a mold interior lower surface.

FIG. 13D is an illustration of a method of using a particular embodiment of the mold shown in FIG. 12 to make the body tissue model, whereby a flowable first layer second amount is being deposited into a mold interior space.

### III. DETAILED DESCRIPTION OF THE PREFERRED EMBODIMENTS

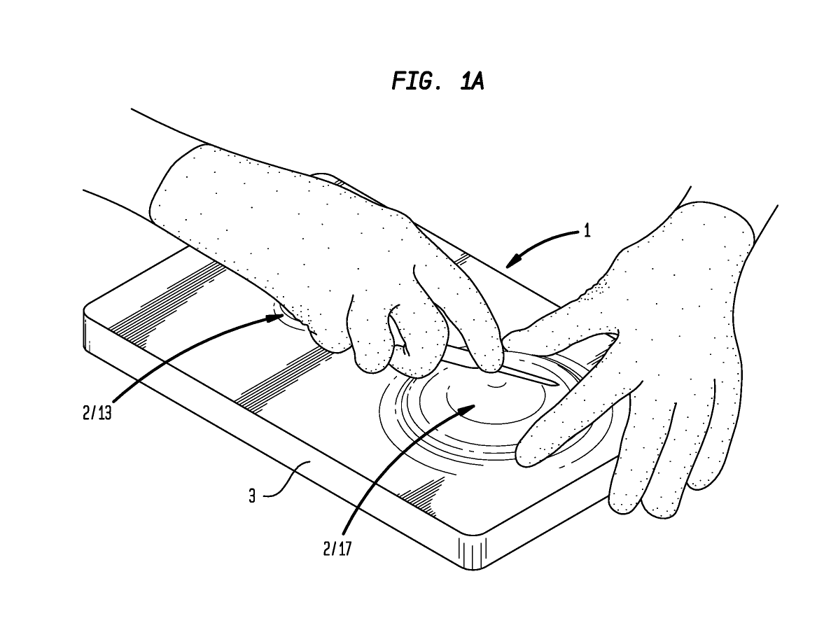

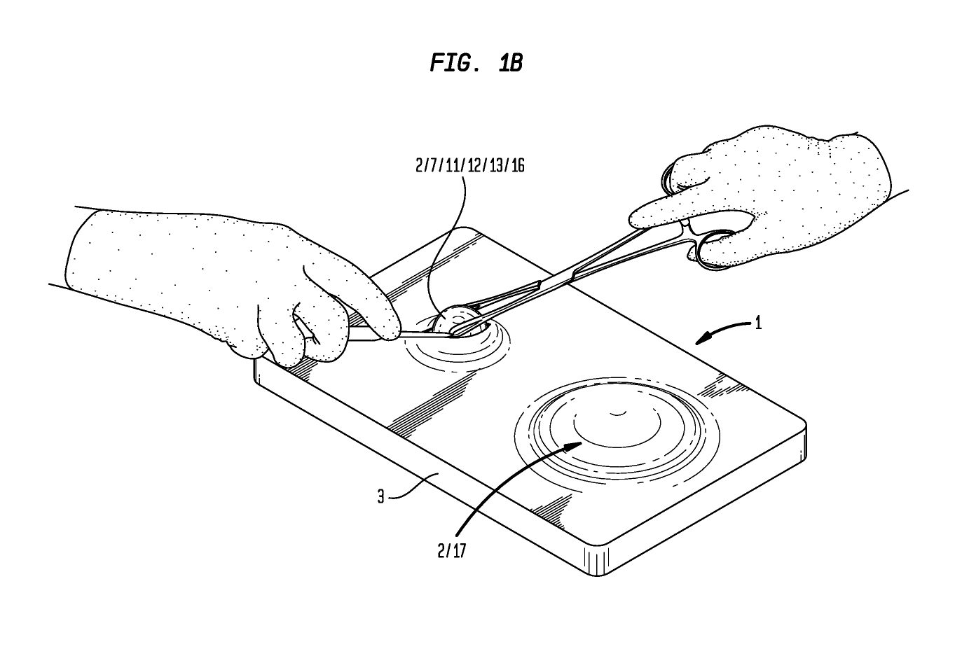

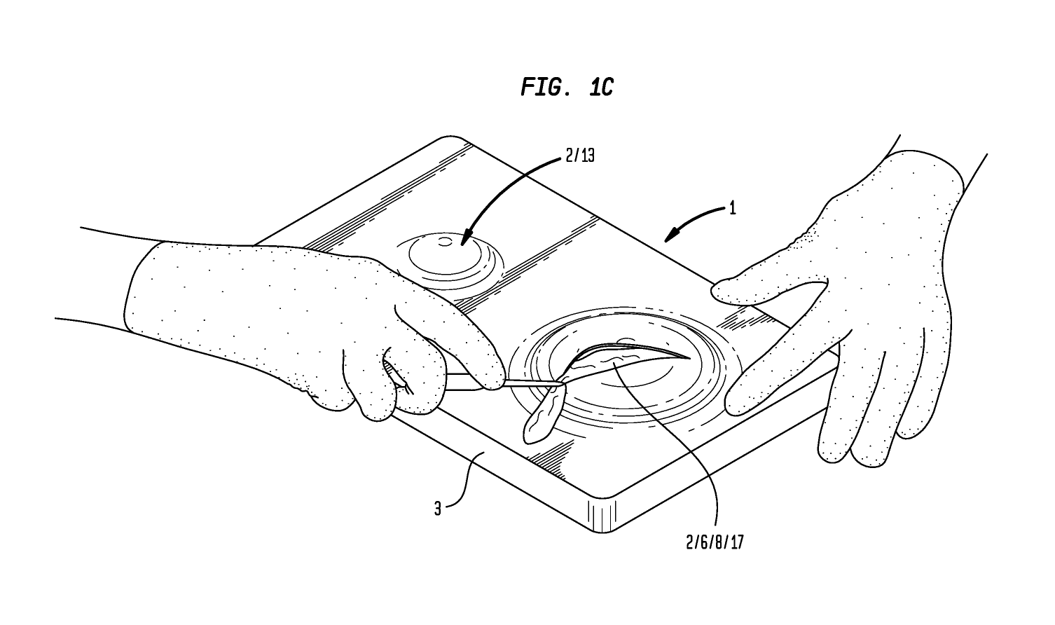

Now referring primarily to FIG. 1A, which illustrates a method of using a particular embodiment of a body tissue model (1) including a simulated pathology (2) for incising which may be useful for honing incision skills, whereby the body tissue model (1) includes simulated body tissue (3) which defines a closed cavity (4) having a closed cavity interior space (5), and a flowable simulated pathological fluid (6) disposed within the closed cavity interior space (5); whereby the flowable simulated pathological fluid (6) provides at least a portion of the simulated pathology (2).

The term “simulated” for the purposes of the present invention means made in imitation of something else.

The term “pathology” for the purposes of the present invention means a deviation from a normal condition. As to particular embodiments, the deviation may be associated with one or more diseases.

The term “flowable” for the purposes of the present invention means capable of flowing at room temperature; not solid.

Now referring primarily to FIG. 1B, as to particular embodiments, the simulated pathology (2) can be an excisable simulated pathology (7), whereby the entirety or substantially the entirety of the excisable simulated pathology (7) can be excised from within the closed cavity interior space (5) as an intact one-piece construct which remains undamaged or substantially undamaged (for example, not ruptured) following the excision. Accordingly, the body tissue model (1) including the excisable simulated pathology (7) may be useful for honing excision skills.

Now referring primarily to FIG. 1C, as to particular embodiments, the simulated pathology (2) can be a drainable simulated pathology (8), whereby the drainable simulated pathology (8) or contents included in the drainable simulated pathology (8) can be drained from within the closed cavity interior space (5). Accordingly, the body tissue model (1) including the drainable simulated pathology (8) may be useful for honing drainage skills.

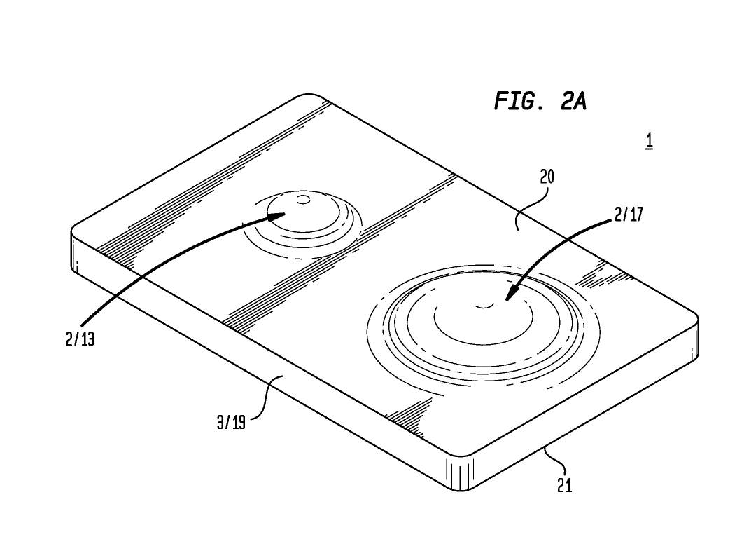

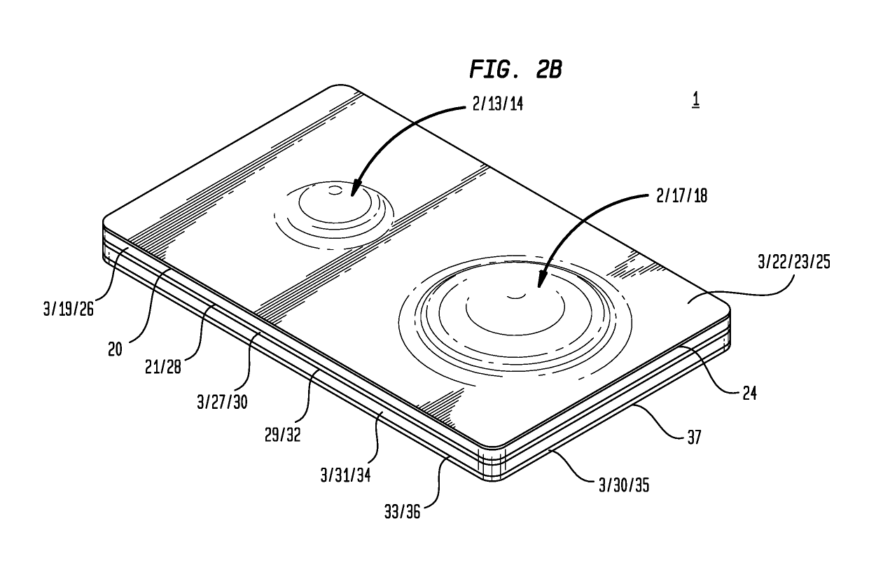

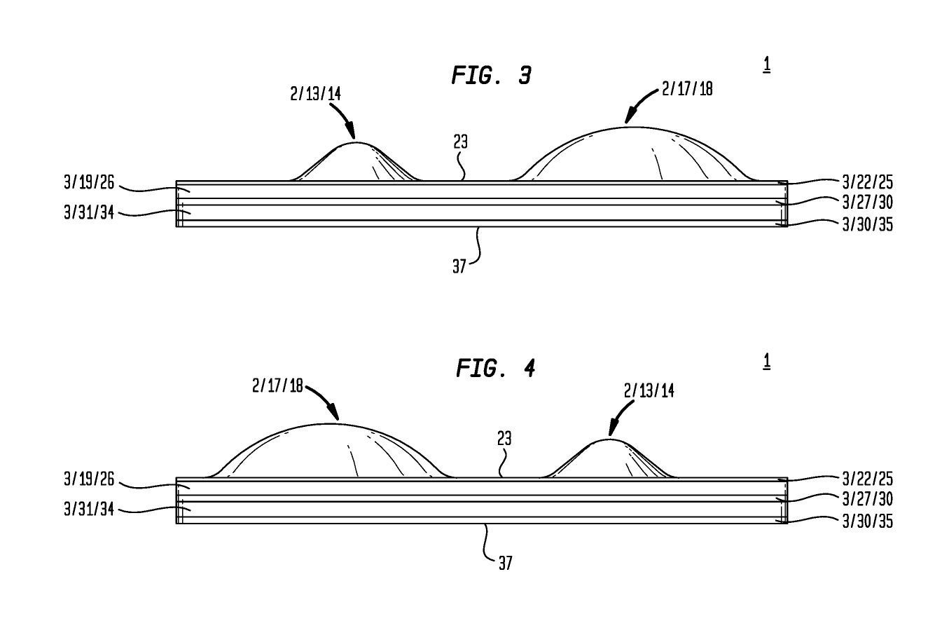

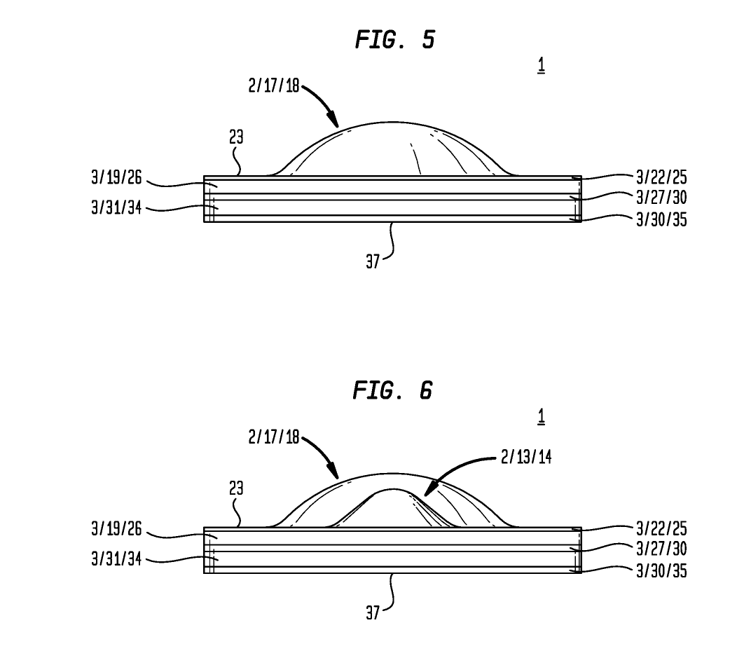

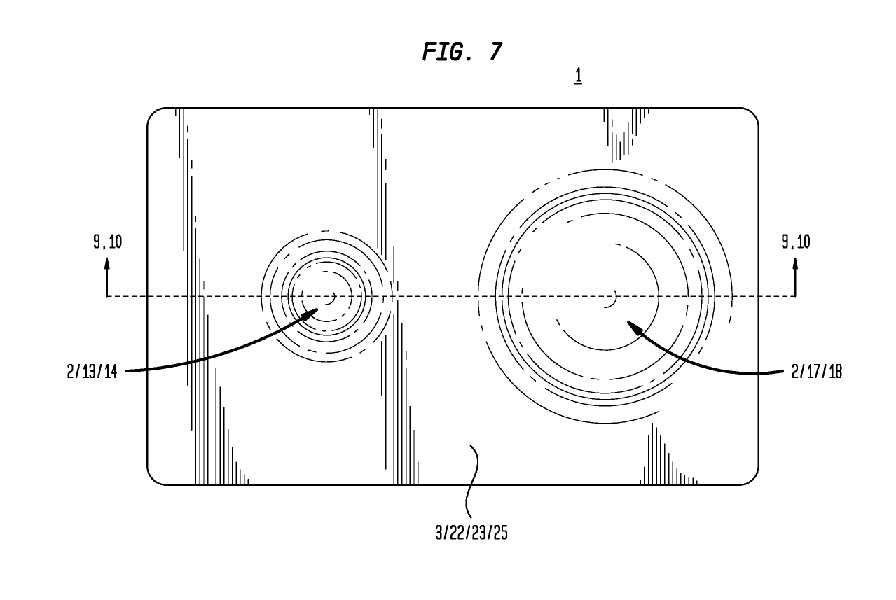

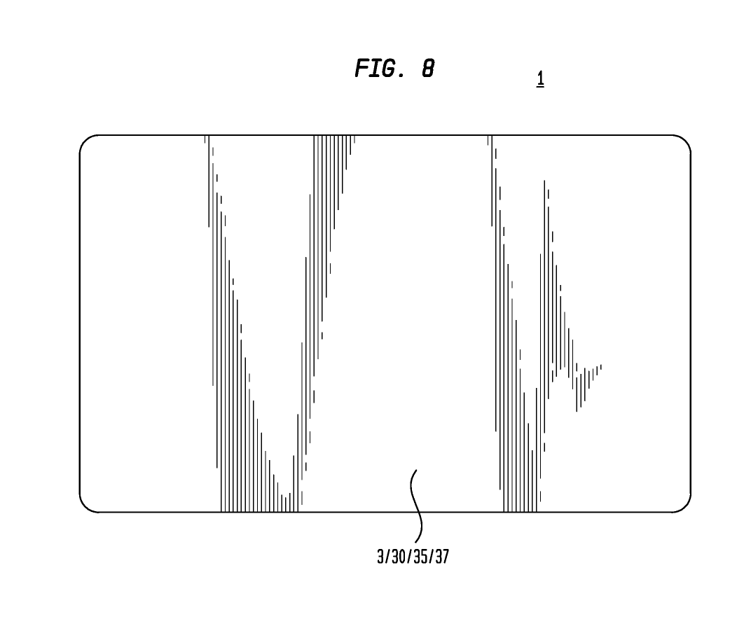

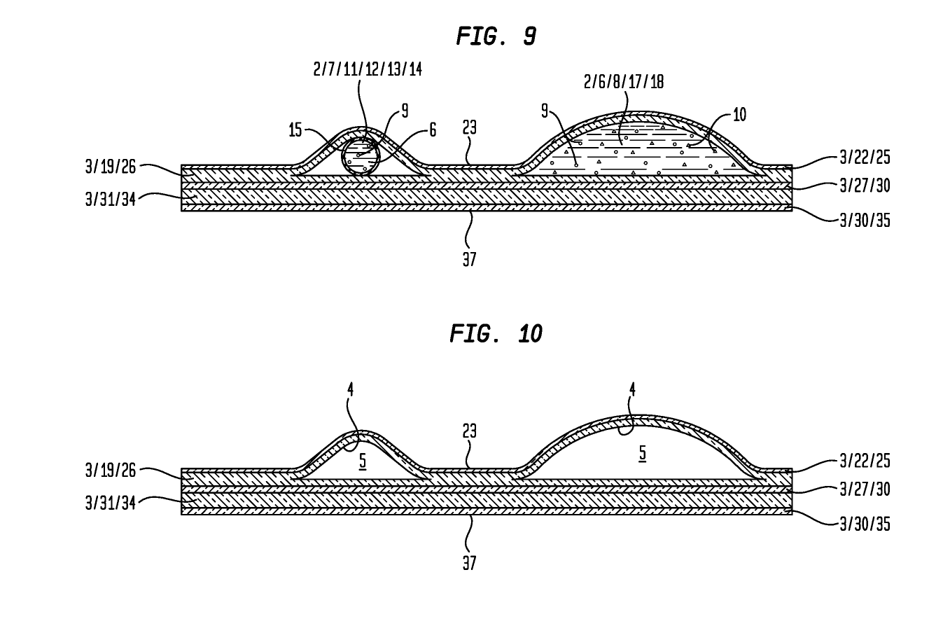

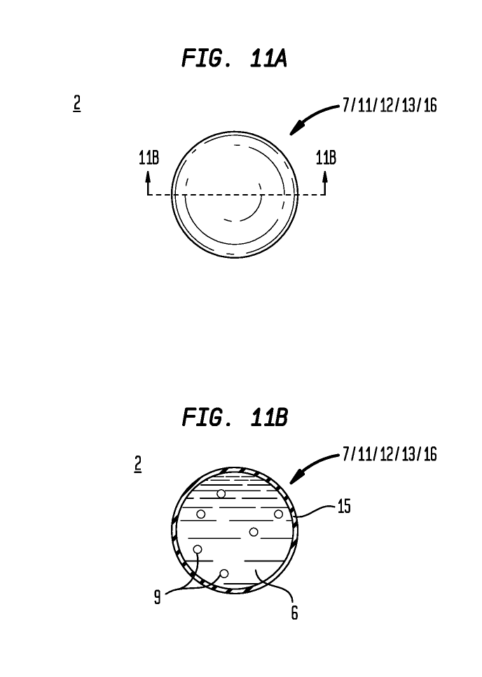

Now referring primarily to FIG. 2A through FIG. 10, the body tissue model (1) having the simulated pathology (2) includes simulated body tissue (3) which defines a closed cavity (4) having a closed cavity interior space (5) (as shown in the example of FIG. 10), and a flowable simulated pathological fluid (6) disposed within the closed cavity interior space (5) (as shown in the example of FIG. 9); whereby the flowable simulated pathological fluid (6) provides at least a portion of the simulated pathology (2). As to particular embodiments, only the flowable simulated pathological fluid (6) can be disposed within the closed cavity interior space (5) or, said another way, the closed cavity interior space (5) can be void of any structure other than the flowable simulated pathological fluid (6).

The term “closed” in reference to the closed cavity (4) of the present invention means that the cavity is not open; thus the cavity is discrete and isolated from the external environment, having no passageway(s) communicating between the interior and exterior of the cavity nor between the interior of the cavity and another discrete space, such as a reservoir.

As to particular embodiments, the flowable simulated pathological fluid (6) (and/or one or more components thereof) can be water-soluble or capable of dissolving in water, which may be useful for facilitating relatively easy cleanup in comparison to flowable simulated pathological fluid (6) which is not water-soluble.

As to particular embodiments, the flowable simulated pathological fluid (6) (and/or one or more components thereof) can be non-staining, whereby the flowable simulated pathological fluid (6) does not stain or leave a mark, whether permanent or semi-permanent, on contacted objects.

As to particular embodiments, the flowable simulated pathological fluid (6) (and/or one or more components thereof) can be biodegradable or capable of being broken down into smaller parts by natural processes, which may be useful for facilitating disposable in comparison to flowable simulated pathological fluid (6) which is not biodegradable.

As to particular embodiments, the flowable simulated pathological fluid (6) can be homogenous or substantially homogenous, meaning of uniform structure or composition throughout. As to particular embodiments, the flowable simulated pathological fluid (6) can remain homogenous for not less than 30 days, for not less than 60 days, or for not less than 90 days, depending upon the desired shelf-life of the body tissue model (1).

The flowable simulated pathological fluid (6) can, but need not necessarily, include an amount of coloring agent (9) which imparts visible color to the flowable simulated pathological fluid (6). The coloring agent (9) can be any of a numerous and wide variety of coloring agents (9) capable of visibly coloring the flowable simulated pathological fluid (6), such as a dye or a pigment, which as to particular embodiments, can be food-safe. As non-limiting examples, the coloring agent (9) or a combination of coloring agents (9) can impart a visible color to the flowable simulated pathological fluid (6) such as white, off-white, light brown, brown, yellow, orange, pink, red, green, etc., which can correspond to the visible color of the pathological fluid that the flowable simulated pathological fluid (6) is intended to simulate.

The flowable simulated pathological fluid (6) can, but need not necessarily, further include an amount of thickening agent (10) which facilitates thickening of the flowable simulated pathological fluid (6), whereby the thickening agent (10) can be any of a numerous and wide variety of thickening agents (10) capable of increasing the viscosity of the flowable simulated pathological fluid (6). As non-limiting examples, the thickening agent (10) can include polysaccharides such as starches, vegetable gums, or pectin; proteins such as collagen, egg whites, furcellaran, or gelatin; sugars such as agar and carrageenan; conventional food thickening agents as are known to those of ordinary skill in the art; or the like; or combinations thereof. As but one illustrative example, the thickening agent (10) can be xanthan gum.

As to particular embodiments, the flowable simulated pathological fluid (6) can, but need not necessarily, further include amounts of additional components, depending upon the application, such as a preservative, fragrance, a texturing agent, etc.

Now referring primarily to FIG. 2A through FIG. 11, as to particular embodiments, the flowable simulated pathological fluid (6) can be encapsulated within a capsule (11) (meaning a closed receptacle or a shell), for example a rupturable capsule (11), to provide encapsulated flowable simulated pathological fluid (12) which disposes within the closed cavity interior space (5), whereby the encapsulated flowable simulated pathological fluid (12) provides the simulated pathology (2). As but one non-limiting example, this particular embodiment of a simulated pathology (2) can simulate a cyst (13), such as a sebaceous cyst (14).

The term “cyst” for the purposes of the present invention means a closed sac or vesicle which contains fluid or semifluid matter, such as liquid.

Importantly, as to particular embodiments, the capsule (11) can be discrete and separable from the closed cavity (4) and the closed cavity interior space (5). In other words, the capsule (11) may not be defined by the simulated body tissue (3) which bounds the closed cavity (4) but instead, may be defined by a capsule wall (15) which is discrete and separable from the simulated body tissue (3) bounding the closed cavity (4).

Following, the capsule (11) and correspondingly, the encapsulated flowable simulated pathological fluid (12), can be movable, such as freely movable or have unrestricted movement, within the closed cavity interior space (5), as the capsule (11) is not coupled to, directly coupled to, connected to, or integrated with the simulated body tissue (3) bounding the closed cavity (4)

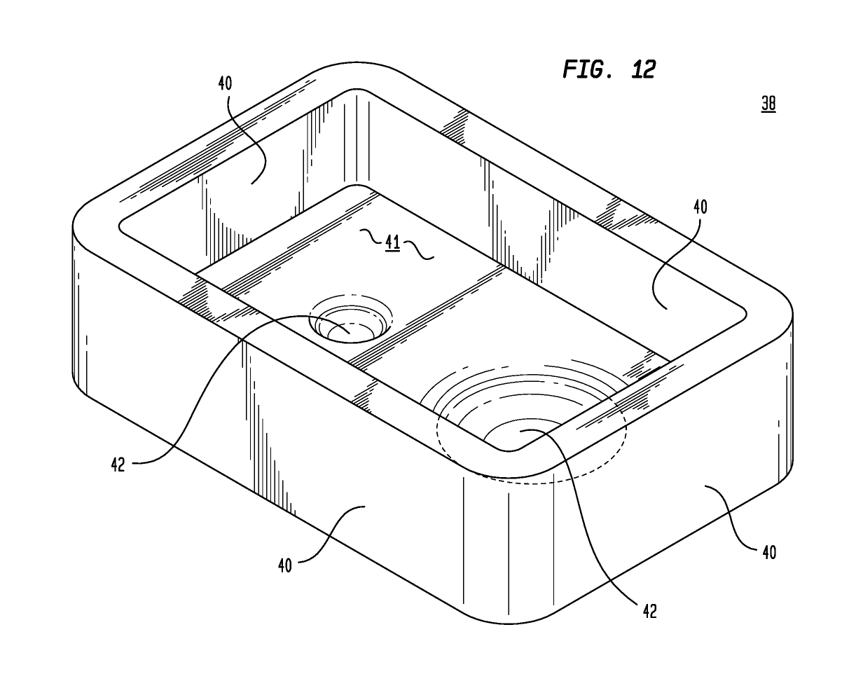

Now referring primarily to FIG. 11A and FIG. 11B, the rupturable capsule (11) can be defined by a capsule wall (15), for example pressure-rupturable capsule wall (15), which encapsulates the flowable simulated pathological fluid (6), whereby the pressure-rupturable capsule wall (15) can be configured to rupture upon application of a predetermined amount of pressure. Upon rupturing, the flowable simulated pathological fluid (6) can egress from within the pressure-rupturable capsule wall (15).

The pressure-rupturable capsule wail (15) can be formed from any of a numerous and wide variety of materials capable of encapsulating flowable simulated pathological fluid (6) and rupturing upon the application of a predetermined amount of pressure. As but one illustrative example, the pressure-rupturable capsule wall (15) can be formed from gelatin or gelatin-like material.

As to particular embodiments, the encapsulated flowable simulated pathological fluid (12) can be configured as a conventional paintball (16), having a pressure-rupturable capsule wall (15) formed from gelatin which encapsulates a coloring agent (9). As but one illustrative example, the paintball (16) can be configured as or akin to a .50 Caliber Paintball.

Now referring primarily to FIG. 2A through FIG. 10, as to other particular embodiments, the flowable simulated pathological fluid (6) can be unencapsulated. Accordingly, the flowable simulated pathological fluid (6) which disposes within the closed cavity interior space (5) provides the simulated pathology (2). As but one non-limiting example, this particular embodiment of a simulated pathology (2) can simulate an abscess (17), such as a subcutaneous abscess (18).

The term “abscess” for the purposes of the present invention means a localized mass of fluid or semifluid matter, such as liquid.

As to this particular embodiment whereby the flowable simulated pathological fluid (6) is not contained within a capsule (11) which is discrete and separable from the closed cavity (4) and the closed cavity interior space (5), the flowable simulated pathological fluid (6) can be contained within the closed cavity interior space (5) by the simulated body tissue (3) bounding the closed cavity (4).

Now referring primarily to FIG. 2A, the body tissue model (1) having the simulated pathology (2) includes simulated body tissue (3) which defines the closed cavity (4) having the closed cavity interior space (5). The simulated body tissue (3) can include a first layer (19) having opposing first layer upper and lower faces (20)(21), whereby the closed cavity (4) disposes between the first layer upper and lower faces (20)(21). The first layer (19) can mimic real body tissue in both appearance and physical characteristics.

In the absence of the simulated pathology (2), the first layer upper and lower faces (20)(21) can be planar or substantially planar, meaning flat or substantially flat. Upon disposition of the simulated pathology (2), whether flowable simulated pathological fluid (6) or encapsulated flowable simulated pathological fluid (12), within the closed cavity interior space (5) of the closed cavity (4) defined by the first layer (19) of simulated body tissue (3), a portion of either one or both of the first layer upper and lower faces (20)(21) can outwardly bulge to accommodate the simulated pathology (2). For example, as shown in FIG. 9, a portion of the first layer upper face (20) above flowable simulated pathological fluid (6) and a portion of the first layer upper face (20) above encapsulated flowable simulated pathological fluid (12) can upwardly bulge.

Now referring primarily to FIG. 2B through FIG. 10, the simulated body tissue (3) can, but need not necessarily, further include one or more additional layers, each of which may also have planar or substantially planar opposing upper and lower faces. As but one illustrative example, the simulated body tissue (3) can further include a second layer (22) having opposing second layer upper and lower faces (23)(24), whereby the second layer (22) can be coupled to the first layer (19) such that the second layer lower face (24) engages with the first layer upper face (20).

As to this particular embodiment, the second layer (22) can be configured to mimic an epidermis-dermis layer (25) and the first layer (19), which defines the closed cavity (4) in which the flowable simulated body fluid (6) is disposed, can be configured to mimic a hypodermis (26) or subcutaneous tissue layer (26). Accordingly, the simulated pathology (2) can simulate a sebaceous cyst (14) or a subcutaneous abscess (18).

Typically in animals (including humans), a real subcutaneous tissue layer (26) primarily comprises adipose tissue and a lesser amount of connective tissue. Accordingly, regarding a first layer (19) which mimics a subcutaneous tissue layer (26), the first layer (19) can be configured to generally simulate adipose tissue, whereby characteristics of the first layer (19), such as thickness, durometer, and color, can be adapted as needed, depending upon the application.

As to particular embodiments, the first layer (19) which mimics a subcutaneous tissue layer (26) can have a lesser resistance to strain in comparison to a second layer (22) which mimics an epidermis-dermis layer (25). In addition, as to particular embodiments, the first layer (19) which mimics a subcutaneous tissue layer (26) can have greasy, soft, and compliant tactile characteristics or the tactile characteristics of harder, denser fat tissue.

Regarding a second layer (22) which mimics an epidermis-dermis layer (25), typically in animals (including humans), a real epidermis is comprised of the outermost layers of cells in the skin, whereby the epidermis can be a stratified squamous epithelium including proliferating basal and differentiated suprabasal keratinocytes which provide a barrier against the environment. The epidermis overlays the dermis, which comprises connective tissue.

As to particular embodiments, the second layer (22) which mimics an epidermis-dermis layer (25) can be resistant to tearing, able to hold a suture, and have limited elasticity. Moreover, as to particular embodiments, the second layer (22) which mimics an epidermis-dermis layer (25) can have a texture, thickness, durometer, color, and surface details that closely simulate a real epidermis and dermis.

Again referring primarily to FIG. 2B through FIG. 10, the simulated body tissue (3) can, but need not necessarily, further include a third layer (27) having opposing third layer upper and lower faces (28)(29), whereby the third layer (27) can be coupled to the first layer (19) such that the third layer upper face (28) engages with the first layer lower face (21).

As to this particular embodiment, the third layer (27) can be configured to mimic a first layer of fascia (30), whereby real fascia comprises a band or sheet of connective tissue fibers beneath the skin which attach, stabilize, enclose, and separate muscles and other internal organs.

Again referring primarily to FIG. 2B through FIG. 10, the simulated body tissue (3) can, but need not necessarily, further include a fourth layer (31) having opposing fourth layer upper and lower faces (32)(33), whereby the fourth layer (31) can be coupled to the third layer (27) such that the fourth layer upper face (32) engages with the third layer lower face (29). As to this particular embodiment, the fourth layer (31) can be configured to mimic muscle tissue (34) which can, but need not necessarily, be colored red.

Again referring primarily to FIG. 2B through FIG. 10, the simulated body tissue (3) can, but need not necessarily, further include a fifth layer (35) having opposing fifth layer upper and lower faces (36)(37), whereby the fifth layer (35) can be coupled to the fourth layer (31) such that the fifth layer upper face (36) engages with the fourth layer lower face (33). As to this particular embodiment, the fifth layer (357) can be configured to mimic a second layer of fascia (30), as described above for the first layer of fascia (30).

A method of making a body tissue model (1) having a simulated pathology (2), as described above, includes generating a first layer (19) of simulated body tissue (3), the first layer (19) defining a closed cavity (4) having a closed cavity interior space (5); and disposing a flowable simulated pathological fluid (6) within the closed cavity interior space (5), whereby the flowable simulated pathological fluid (6) provides at least a portion of the simulated pathology (2).

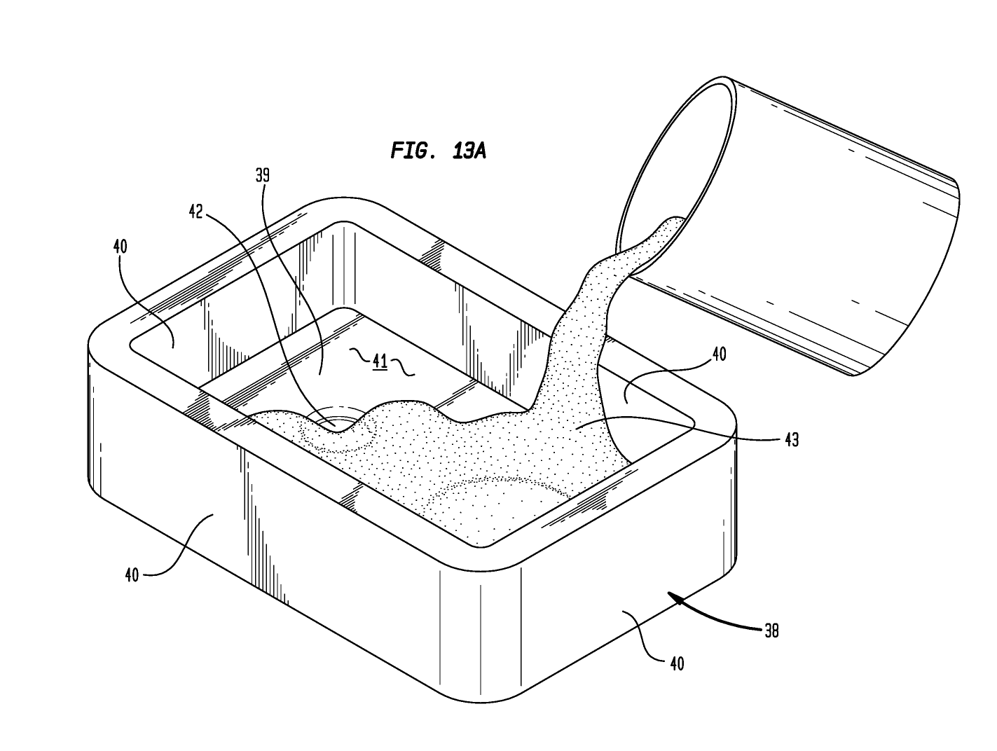

Now referring primarily to FIG. 12, the method can, but need not necessarily, further include using a mold (38) to generate the first layer (19) of simulated body tissue (3) which defines the closed cavity (4) having the closed cavity interior space (5), whereby the mold (38) includes a mold interior lower surface (39) configured to mimic a negative of a surface of a body tissue which the simulated body tissue (3) is intended to simulate.

The mold interior lower surface (39) can be surrounded by mold walls (40) which upwardly extend from the mold interior lower surface (39). The mold walls (40), together with the mold interior lower surface (39), define a mold interior space (41).

Further, the mold (38) can include one or more recesses (42) disposed within the mold interior lower surface (39), whereby each recess (42) extends into the mold interior lower surface (39) to form a negative of a portion of the closed cavity (4) which defines the closed cavity interior space (5).

As to particular embodiments, the recess (42) can be configured as a portion of a sphere, for example as a hemisphere, thereby providing a substantially hemispherical portion of the closed cavity (4) upon generation of the first layer (19).

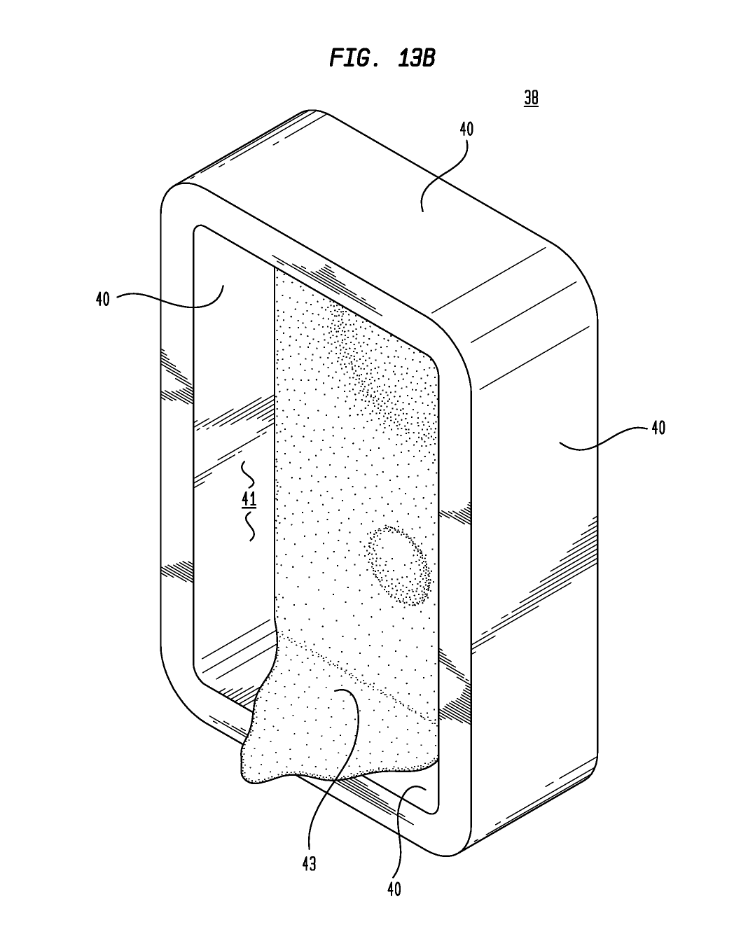

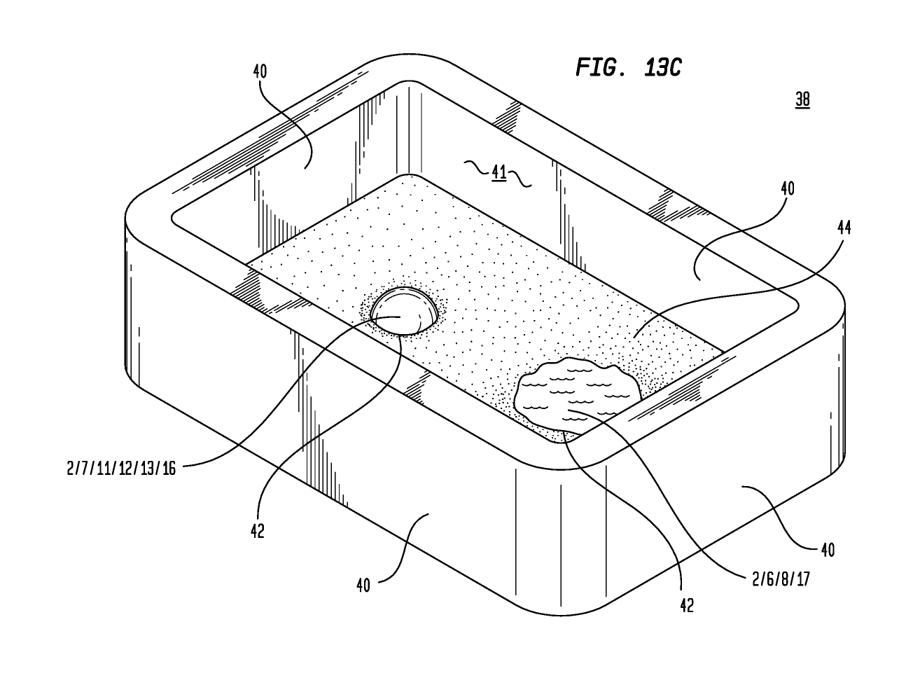

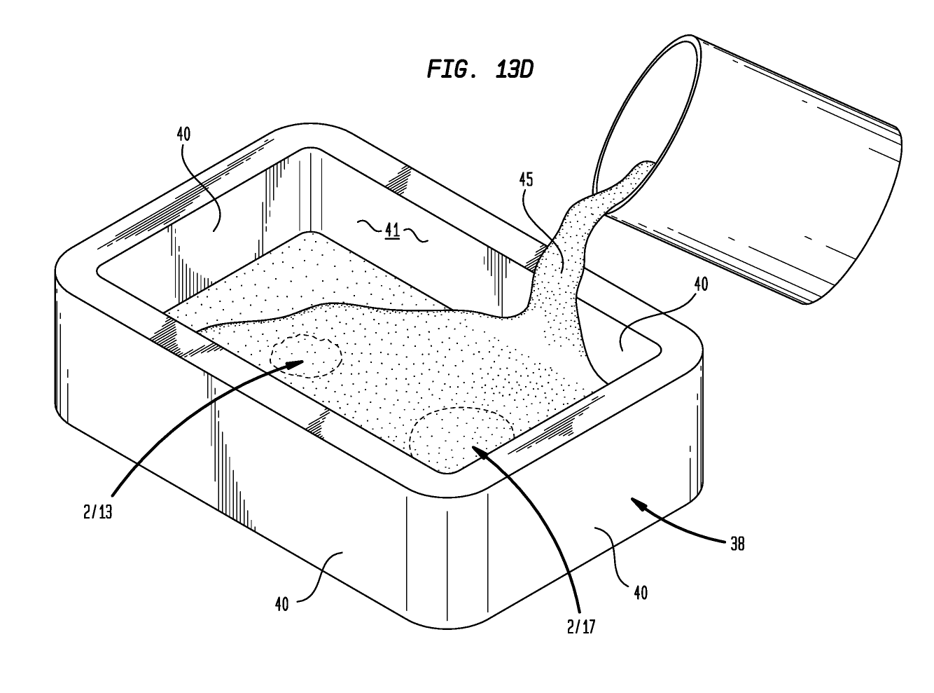

Now referring primarily to FIG. 13A, the method can, but need not necessarily, further include overlaying the mold interior lower surface (39) including the recess (42) with a flowable first layer first amount (43), for example by depositing the flowable first layer first amount (43) into the mold interior space (41).

As to particular embodiments, the mold (38) can be positioned such that the mold interior lower surface (39) disposes in a substantially horizontal position for deposition of the flowable first layer first amount (43) into the mold interior space (41), whereby as an illustrative example, the deposition can be achieved by pouring.

Now referring primarily to FIG. 13B, to ensure generation of a cured first layer first amount (44) having a substantially uniform thickness upon curing, following deposition of the flowable first layer first amount (43) to overlay the mold interior lower surface (39) including the recess (42), the mold (38) can then be positioned in angled relation relative to the substantially horizontal position described above so that excess flowable first layer first amount (43) does not accumulate on the mold interior lower surface (39), and particularly, in the recess (42).

Following, the flowable first layer first amount (43) can cure to provide the cured first layer first amount (44).

Now referring primarily to FIG. 13C, the method further includes disposing the flowable simulated pathological fluid (6) within the recess (42) which defines a portion of the closed cavity (4) and correspondingly, the closed cavity interior space (5).

As to particular embodiments, the flowable simulated pathological fluid (6) can be deposited into the recess (42) as a fluid flow, for example by pouring, which, as a non-limiting example, can provide a simulated abscess (17) upon generation of the first layer (19).

As to particular embodiments, the flowable simulated pathological fluid (6) can be pretreated prior to deposition into the recess (42). As but one illustrative example, pretreatment of the flowable simulated pathological fluid (6) can include degassing.

As to other particular embodiments, the flowable simulated pathological fluid (6) can be configured as encapsulated flowable simulated pathological fluid (12), which can be deposited into the recess (42) as a one-piece construct. As a non-limiting example, the encapsulated flowable simulated pathological fluid (12) can provide a simulated cyst (13) upon generation of the first layer (19).

As to particular embodiments, the encapsulated flowable simulated pathological fluid (12) can be pretreated prior to deposition into the recess (42). For example, as to particular embodiments having an encapsulated flowable simulated pathological fluid (12) configured as a conventional paintball (16), each paintball (16) can be immersed in a solvent, such as water, for a time period effective to soften the paintball (16) relative to its pre-immersed condition. As to particular embodiments, prior to immersion, each paintball (16) can be coated with a release agent, such as EASE RELEASE® 200, which can be obtained from Mann Formulated Products, 2000 Saint John Street, Easton, Pa., 18042, USA.

Following deposition of the flowable simulated pathological fluid (12) within the recess (42), the method can, but need not necessarily, further include overlaying the cured first layer first amount (44) and the flowable simulated pathological fluid (6) disposed within the recess (42) with a flowable first layer second amount (45), for example by depositing the flowable first layer second amount (45) into the mold interior space (41).

Following, the flowable first layer second amount (45) can cure to provide a cured first layer second amount and consequently, a first layer (19) including a flowable simulated pathological fluid (6) within the closed cavity interior space (5) between the first layer upper and lower faces (20)(21).

As to particular embodiments, the method can, but need not necessarily, further include generating additional layers of simulated body tissue (3), such as the second, third, fourth, and fifth layers (22)(27)(31)(35) described above, which can each be formed from the deposition of one or more corresponding layers within the mold interior space (41).

For example, as to particular embodiments having a first layer (19) which mimics a subcutaneous tissue layer (26) and a second layer (22) which mimics an epidermis-dermis layer (25), the a flowable second layer (22) can firstly be deposited within the mold interior space (41) to overlay the mold interior lower surface (39) including the recess (42), as described above for the flowable first layer first amount (43). Following curing of the second layer (22), the flowable first layer first amount (43) can be deposited within the mold interior space (41) to overlay the cured second layer (22). Upon curing to provide the cured first layer first amount (44), the flowable simulated pathological fluid (6) and the flowable first layer second amount (45) can be added as described above to provide the first layer (19) including the flowable simulated pathological fluid (6) within the closed cavity interior space (5) between the first layer upper and lower faces (20)(21).

As to particular embodiments, one or more of the third, fourth, and fifth layers (27)(31)(35) can be deposited within the mold interior space (41) to overlay the first layer (19) including the flowable simulated pathological fluid (6) within the closed cavity interior space (5) between the first layer upper and lower faces (20)(21), whereby the adjacent layer has cured prior to deposition of subsequent layers.

Each of the first, second, third, fourth, and fifth layers (19)(22)(27)(31)(35) can be substantially formed of a silicone rubber and can mimic real body tissue in both appearance and physical characteristics.

As to particular embodiments, each of the first, second, third, fourth, and fifth layers (19)(22)(27)(31)(35) can be substantially formed as described in U.S. Pat. No. 8,915,742, which is incorporated by reference herein.

As can be easily understood from the foregoing, the basic concepts of the present invention may be embodied in a variety of ways. The invention involves numerous and varied embodiments of a body tissue model including a simulated pathology and methods for making and using such a body tissue model including a simulated pathology, including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “layer” should be understood to encompass disclosure of the act of “layering”—whether explicitly discussed or not—and, conversely, were there effectively disclosure of the act of “layering”, such a disclosure should be understood to encompass disclosure of a “layer” and even a “means for layering”. Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the body tissue models including a simulated pathology herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A body tissue model including a simulated pathology, said body tissue model comprising:
simulated body tissue which defines a closed cavity having a closed cavity interior space; and
a flowable simulated pathological fluid disposed within said closed cavity interior space;
wherein said flowable simulated pathological fluid provides at least a portion of said simulated pathology.

2. The body tissue model of claim 1, wherein said simulated pathology comprises an excisable simulated pathology.

3. The body tissue model of claim 1, wherein said simulated pathology comprises a drainable simulated pathology.

4-12. (canceled)

13. The body tissue model of claim 1, wherein said flowable simulated pathological fluid is encapsulated within a rupturable capsule to provide encapsulated flowable simulated pathological fluid.

14. The body tissue model of claim 13, wherein said encapsulated flowable simulated pathological fluid is designed to simulate a cyst.

15. The body tissue model of claim 13, wherein said rupturable capsule comprises a pressure-rupturable capsule wall which encapsulates said flowable simulated pathological fluid.

16. The body tissue model of claim 15, wherein said pressure-rupturable capsule wall comprises gelatin or gelatin-like material.

17. The body tissue model of claim 13, wherein said encapsulated flowable simulated pathological fluid is configured as a paintball.

18. The body tissue model of claim , wherein said flowable simulated pathological fluid is unencapsulated.

19. The body tissue model of claim 18, wherein said flowable simulated pathological fluid is designed to simulate an abscess.

20. The body tissue model of claim 1, wherein said simulated body tissue further comprises:
a first layer having opposing first layer upper and lower faces;
wherein said closed cavity disposes between said first layer upper and lower faces.

21. The body tissue model of claim 20, wherein said simulated body tissue further comprises:
a second layer having opposing second layer upper and lower faces;
wherein said second layer lower face overlays said first layer upper face.

22. The body tissue model of claim 21, wherein:
said second layer is designed to simulate an epidermis-dermis layer; and
said first layer is designed to simulate a subcutaneous tissue layer.

23. The body tissue model of claim 22, wherein said simulated pathology is designed to simulate a sebaceous cyst.

24. The body tissue model of claim 22, wherein said simulated pathology is designed to simulate a subcutaneous abscess.

25. The body tissue model of claim 22, wherein said simulated body tissue further comprises:
a third layer having opposing third layer upper and lower faces;
wherein said third layer upper face overlays said first layer lower face.

26. The body tissue model of claim 25, wherein said third layer is designed to simulate a first layer of fascia.

27. The body tissue model of claim 26, wherein said simulated body tissue further comprises:
a fourth layer having opposing fourth layer upper and lower faces;
wherein said fourth layer upper face overlays said third layer lower face.

28. The body tissue model of claim 27, wherein said fourth layer is designed to simulate muscle tissue.

29. The body tissue model of claim 28, wherein said simulated body tissue further comprises:
a fifth layer having opposing fifth layer upper and lower faces;
wherein said fifth layer upper face overlays said fourth layer lower face.

30. The body tissue model of claim 29, wherein said fifth layer is designed to simulate a second layer of fascia.

31-62. (canceled)
